(19) United States
(12) Patent Application Publication
(10) Pub. No.: US 2025/0232131 A1
(43) Pub. Date: Jul. 17, 2025

(54) DIALOG INSPECTION SYSTEM USING OPEN ENDED QUESTIONS

(71) Applicant: NEC Corporation Of America, Herzlia (IL)

(72) Inventors: Tsvi LEV, Tel-Aviv (IL); Yaacov HOCH, Ramat-Gan (IL)

(73) Assignee: NEC Corporation Of America, Herzlia (IL)

(21) Appl. No.: 18/412,671

(22) Filed: Jan. 15, 2024

(51) Int. Cl. G06F 40/40

(52) U.S. Cl. CPC G06F 40/40

(57) ABSTRACT

A system and a method for analyzing conversation text model comprising an inspection model, using a neural network based language model. The method may be used for investigation, as a tutor or examination bot, for mental state health screening, and for adapting a bot to covert preferences. Some implementations may ask the same question several times in different forms, to check the consistency or lead a conversation implicitly.

### FIELD AND BACKGROUND OF THE INVENTION

The present invention, in some embodiments thereof, relates to text inspection, and, more particularly, but not exclusively, usage of generative conversational language models for dialog inspection.

Automated conversation agents are implemented in many contexts, for example automating examinations in school, regulatory tests, cognitive state tests, investigations, and the likes. Known automatic examination bots are predominantly based on closed ended questions, which are readily automatically checked.

Substantial logic infrastructure of examination and customer service bots, powered by computerized agents, also used for virtual assistants has been developed. These bots may utilize artificial intelligence and natural language processing to provide personalized experiences. Examination bots assist with tasks such as quizzes and test preparation by understanding user queries, retrieving relevant information, and improving their performance through machine learning. Customer service bots may automate support by interpreting user inputs, generating appropriate responses, and learning from past interactions.

For example, natural language processing enables comprehension of user inputs, while dialogue management ensures context-aware conversations. Knowledge graphs and databases may store information, and/or facilitate access to relevant facts. Machine learning algorithms drive learning from user interactions, refining the bots' abilities over time.

Advancements in deep learning and neural networks have bolstered these bots' capabilities, but challenges remain in understanding complex queries and delivering human-like interactions. For example, people are often either unaware of effects on their mental and emotional states, and in some cases may be motivated to disparage or conceal their feelings. Detecting implicit content from a conversation, where open ended questions are used, may be beneficial for many applications.

### SUMMARY OF THE INVENTION

It is an object of the present invention to provide a system and a method for dialog inspection using an ensemble of inspection questions and a model comprising conversational language model.

According to an aspect of some embodiments of the present invention there is provided a method for evaluating understanding in a textual content, comprising:
accessing a storage to obtain a plurality of inspection questions;
acquiring a textual content, using a virtual human interaction agent;
using at least one processing circuitry for generating:
   a plurality of queries each from a combination of at least one part of the textual content and one of the plurality of inspection questions;
   a plurality of inference values, each by feeding one of the plurality of queries to at least one conversational language model; and
   at least one evaluation of the textual content by processing the plurality of inference.

According to an aspect of some embodiments of the present invention there is provided a system comprising a storage and at least one processing circuitry configured to:
access the storage to obtain a plurality of inspection questions;
acquire a textual content, using a virtual human interaction agent;
use the at least one processing circuitry for generating:
   a plurality of queries each from a combination of at least one part of the textual content and one of the plurality of inspection questions;
   a plurality of inference values, each by feeding one of the plurality of queries to at least one conversational language model; and
   at least one evaluation of the textual content by processing the plurality of inference.

According to an aspect of some embodiments of the present invention there is provided one or more computer program products comprising instructions for evaluating understanding in a textual content, wherein execution of the instructions by one or more processors of a computing system is to cause a computing system to:
access a storage to obtain a plurality of inspection questions;
acquire a textual content, using a virtual human interaction agent;
use at least one processing circuitry for generating:
   a plurality of queries each from a combination of at least one part of the textual content and one of the plurality of inspection questions;
   a plurality of inference values, each by feeding one of the plurality of queries to at least one conversational language model; and
   at least one evaluation of the textual content by processing the plurality of inference.

Optionally, further comprising using the at least one evaluation to generate at least one prompt, and using the at least one prompt for querying a user for an additional textual content.

Optionally, the at least one prompt comprising a suggestion derived from the at least one evaluation.

Optionally, the suggestion is deliberately erroneous.

Optionally, the suggestion comprising an unsolvable puzzle question.

Optionally, the suggestion is a request to rephrase a part of the textual content.

Optionally, the at least one evaluation comprising evaluating presence of items from the at least one prompt in the textual content.

Optionally, the at least one evaluation is inferring a mental state induced by the least one second prompt.

Optionally, the at least one evaluation pertains to consistency of reactions to a plurality of prompts from the virtual human interaction agent, wherein the plurality of prompts are characterized by equivalence.

Optionally, the at least one evaluation is inferring a mental condition of a user interacting with the virtual human interaction agent.

Optionally, the at least one evaluation is inferring an emotional state of a user interacting with the virtual human interaction agent.

Optionally, the evaluation comprising using the at least one conversational language model to check correctness and completeness of the textual content.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for dialog inspection, according to some embodiments of the present disclosure;

FIG. 2 is a schematic diagram of a simplified exemplary dialog inspection module, according to some embodiments of the present disclosure;

FIG. 3 is a flowchart of an exemplary process for dialog inspection, according to some embodiments of the present disclosure; and

FIG. 4 is an exemplary query to a large language mode and a corresponding inference, according to some embodiments of the present disclosure.

### DESCRIPTION OF SPECIFIC EMBODIMENTS OF THE INVENTION

The present invention, in some embodiments thereof, relates to text inspection, and, more particularly, but not exclusively, usage of generative conversational language models for dialog inspection.

Some embodiments of the present invention feed a language model with queries prepared using an ensemble of open-ended questions on a text acquired during interaction of a virtual human interaction agent with a user.

Some embodiments of the present invention process the conversation using a generative AI system which may be used for text inferring, for example by answering about a given text whether it contains a certain topic, discusses a certain object or operation, has a negative or positive or violent sentiment and/or the like. For example, such a system may comprise a model comprising an inspection model, using a large language model (LLM) and an interaction model. These generative AI systems may be used to analyze answers to open ended questions, in addition to generating answers and/or develop conversations about a given text.

An interaction model may use a LLM to infer whether an interaction input contains a certain topic, discusses a certain object or operation, characterized by a negative or positive or violent sentiment and/or the likes.

Some implementations may ask the same question several times in different forms, to check the consistency of the user's answer. Note that statements may lead a conversation implicitly, rather than posed as questions, for example by making a certain statement, suggestion, or the like, just like a therapist may, to see if the user reacts in a certain way.

Some embodiments of the present invention enable automating conversations while attending to subtext, where biases can be detected using a variety of statistical and artificial intelligence explainability schemes, and enabling balancing with privacy. Some embodiments of the present invention may be also used to collect statistics about interaction patterns.

Some embodiments of the present invention use the LLM to process the user's responses to ensembles of questions, enables performing various examinations without depending on closed form or explicit questions.

Some embodiments of the present invention may receive text directly or apply extraction thereof form a video, a vocal recording, and/or the like.

Some embodiments of the present invention may apply pre-processing extracting text from voice, and/or such as translation and filter text for known weaknesses of the translation and/or the conversational language model. The conversational language model may be a large language model trained for various purposes which may not necessarily comprise text classification.

Some embodiments of the present invention wrap the text with queries prepared for a classification, and apply a pre-trained conversational language mode, which may be transformer neural network based, in the wrapped text.

Some embodiments of the present invention extract closed ended inferences from a text generated by the model, and apply a preset function or an additional machine learning model to produce classification of the text.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

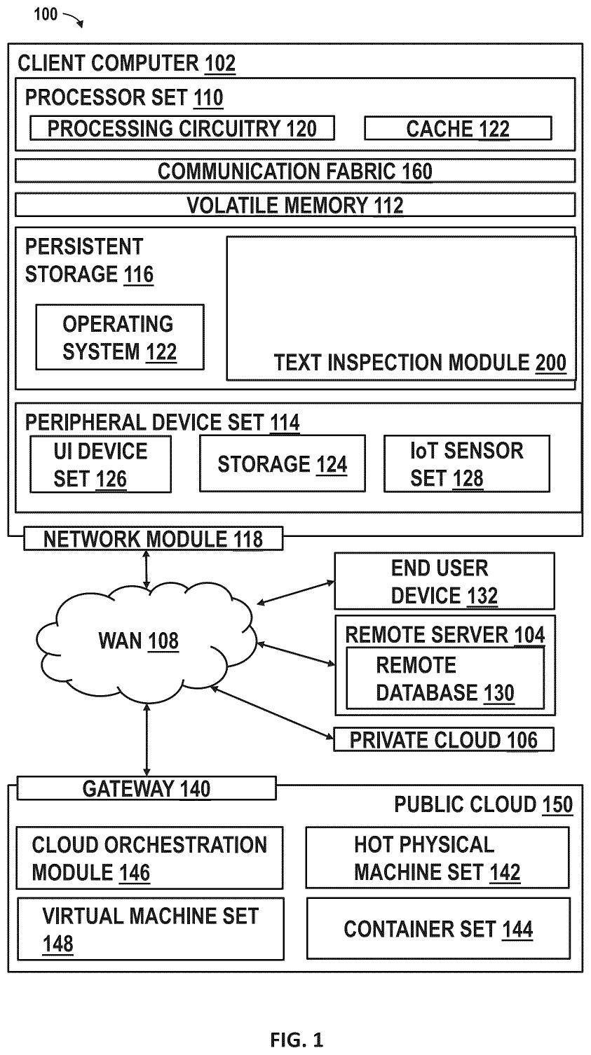

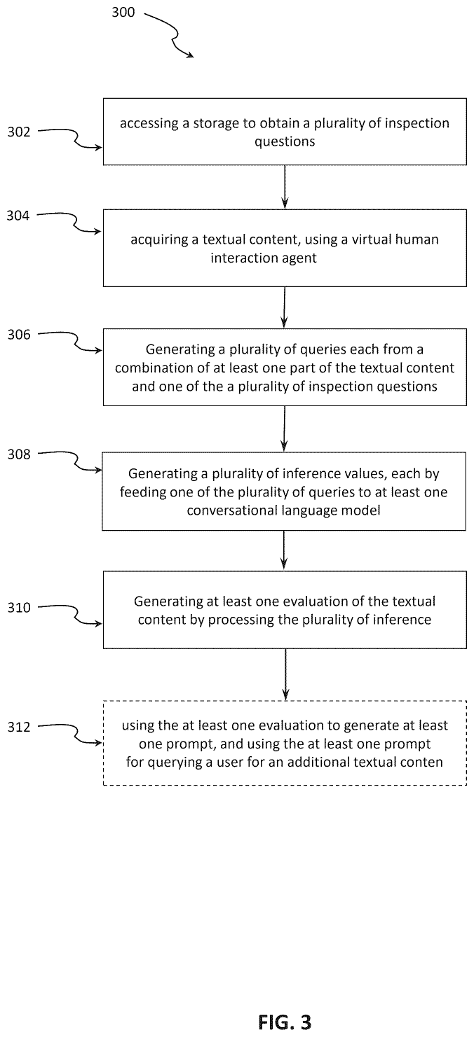

Referring now to the drawings, FIG. 1 is a schematic illustration of an exemplary system for dialog inspection, according to some embodiments of the present disclosure. An exemplary client computer system 100 may be used for executing execute processes such as 300 for dialog inspection. Further details about these exemplary processes follow as FIG. 3 are described.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations may be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a dialog inspection module 200. In addition to block 200, computing environment 100 includes, for example, computer 102, wide area network (WAN) 108, end user device (EUD) 132, remote server 104, public cloud 150, and private cloud 106. In this embodiment, computer 102 includes processor set 110 (including processing circuitry 120 and cache 134), communication fabric 160, volatile memory 112, persistent storage 116 (including operating system 122 and block 200, as identified above), peripheral device set 114 (including user interface (UI), device set 126, storage 124, and Internet of Things (IoT) sensor set 128), and network module 118. Remote server 104 includes remote database 130. Public cloud 150 includes gateway 140, cloud orchestration module 146, host physical machine set 142, virtual machine set 148, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. For example, a processor set may include one or more of a central processing unit (CPU), a microcontroller, a parallel processor, supporting multiple data such as a digital signal processing (DSP) unit, a graphical processing unit (GPU) module, and the like, as well as optical processors, quantum processors, and processing units based on technologies that may be developed in the future. Processing circuitry 120 may be distributed over multiple packages, for example, multiple, coordinated integrated circuit chips. Processing circuitry 120 may implement multiple processor threads and/or multiple processor cores. Cache 134 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 134 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 116.

COMMUNICATION FABRIC 160 is the signal conduction paths that allow the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 116 is any form of non-volatile storage for computers that is now known or to be developed in the future. The non-volatility of this storage means that the stored data is maintained regardless of whether power is being supplied to computer 102 and/or directly to persistent storage 116. Persistent storage 116 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 126 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 128 is made up of sensors that can be used in Internet of Things applications. For example, one sensor may be a thermometer and another sensor may be a motion detector.

NETWORK MODULE 118 is the collection of computer software, hardware, and firmware that allows computer 102 to communicate with other computers through WAN 108. Network module 118 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 118 are performed on the same physical hardware device. In other embodiments (for example, embodiments that utilize software-defined networking (SDN)), the control functions and the forwarding functions of network module 118 are performed on physically separate devices, such that the control functions manage several different network hardware devices. Computer readable program instructions for performing the inventive methods can typically be downloaded to computer 102 from an external computer or external storage device through a network adapter card or network interface included in network module 118.

WAN 108 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 132 is any computer system that is used and controlled by an end user (for example, a customer of an enterprise that operates computer 102), and may take any of the forms discussed above in connection with computer 102. EUD 132 typically receives helpful and useful data from the operations of computer 102. For example, in a hypothetical case where computer 102 is designed to provide a recommendation to an end user, this recommendation would typically be communicated from network module 118 of computer 102 through WAN 108 to EUD 132. In this way, EUD 132 can display, or otherwise present, the recommendation to an end user. In some embodiments, EUD 132 may be a client device, such as thin client, heavy client, mainframe computer, desktop computer and so on.

REMOTE SERVER 104 is any computer system that serves at least some data and/or functionality to computer 102. Remote server 104 may be controlled and used by the same entity that operates computer 102. Remote server 104 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 104.

PUBLIC CLOUD 150 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 150 is performed by the computer hardware and/or software of cloud orchestration module 146. The computing resources provided by public cloud 150 are typically implemented by virtual computing environments that run on various computers making up the computers of host physical machine set 142, which is the universe of physical computers in and/or available to public cloud 150. The virtual computing environments (VCEs) typically take the form of virtual machines from virtual machine set 148 and/or containers from container set 144. It is understood that these VCEs may be stored as images and may be transferred among and between the various physical machine hosts, either as images or after instantiation of the VCE. Cloud orchestration module 146 manages the transfer and storage of images, deploys new instantiations of VCEs and manages active instantiations of VCE deployments. Gateway 140 is the collection of computer software, hardware, and firmware that allows public cloud 150 to communicate through WAN 108.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 150, except that the computing resources are only available for use by a single enterprise. While private cloud 106 is depicted as being in communication with WAN 108, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 150 and private cloud 106 are both part of a larger hybrid cloud.

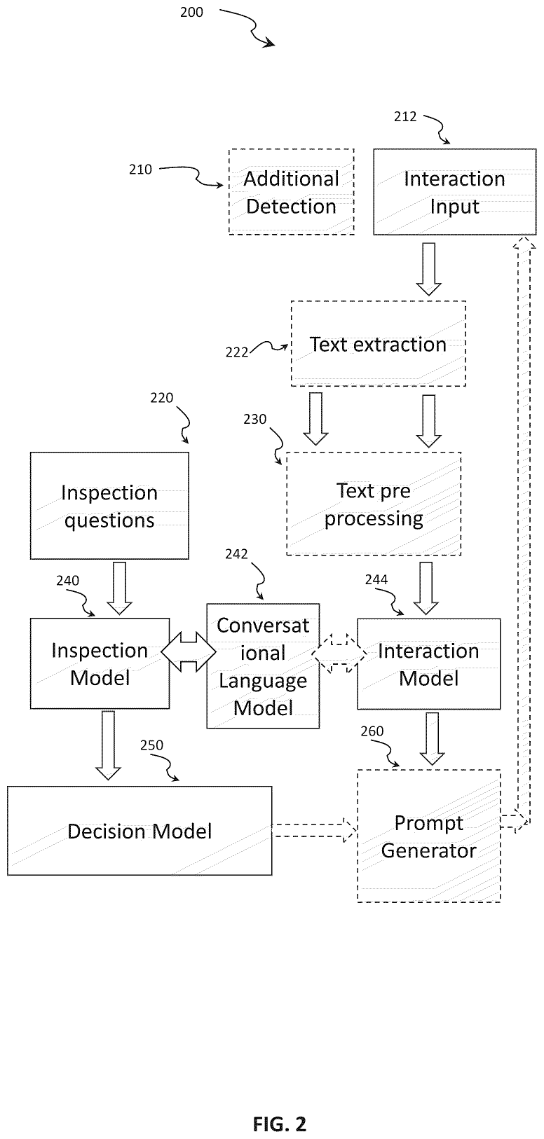

Referring now to FIG. 2, which is a schematic diagram of a simplified exemplary dialog inspection module, according to some embodiments of the present disclosure.

The diagram describes the primary essential and an optional architectural component of the dialog inspection module 200.

The optional additional detection 210 may be a visual, audio, thermal, electric or other sensor adapted for acquiring non-verbal cues from the user. These non-verbal cues may comprise hand gestures, facial expressions, pose, speech tone, heart rate, and/or the like.

The interaction input 212 may be a video, audio, a sequence of one or more button presses, hand gestures and/or the like, which may convey a message using a language. The textual content may be derived from the interaction from the user, and may be in a variety of languages, dialects, jargons, and the likes, such as a natural language such as English, Spanish, Bengali, a sign language and/or the like.

The interaction input 212 may be received from an end user device 132, the public cloud 150, the UI device set 126, and/or the like, and it may be a text message, an email, a letter, a blog post, a question, and/or the like.

The inspection questions 220 may be based on one or more checklists to evaluate a student proficiency, a witness reliability, a medical condition, a personality trait, and/or the like. The inspection questions may be either close ended or open-ended questions and may be based on one or more domain knowledge checklists, questionnaires, key point lists, and/or the like.

For example, “Does the use understand the concept of entropy in the context introduced by the former prompt”, or “What emotional subtext may be implied by the choice of terms”.

In some implementations, inspection questions relate to the correctness and completeness of the textual content.

For example, “Does the following text answer the prompt correctly?”, “does the following text skip a significant element of a steam engine description?” or “is the following paragraph consistent with the opening sentence?”.

Some implementations may use the at least one conversational language model to check correctness and completeness of the textual content, for example “did the answer . . . mention the three most popular books mentioning Cleopatra?”.

In some implementations, the plurality of close ended questions comprises pairs, trios, and/or larger sets of synonymous, or near synonymous questions, for reducing the risk of mistakes by the model. Other questions may be partially overlapping to existing ones in the question list.

These implementations may help the inspection model generate evaluations, pertaining to consistency of reactions to a plurality of prompts from the virtual human interaction agent, wherein the plurality of prompts are characterized by similarity or equivalence.

For example, “does the following sentence contradict the following sentence” and “Is there an antonym of a statement from the previous one in:”.

In examples comprising a deliberately erroneous suggestion, a suggestion comprising an unsolvable puzzle, and/or the like made by the interaction model, an inspection question may be open ended such as “what did the user understand from the suggestion”, or “how did the user respond to this suggestion” or close ended like “did the user notice something wrong with the former suggestion”. These suggestion may be used to check user attention, sincerity, creativity, and/or the like.

In some implementations, the suggestion may be is a request to rephrase a part of the textual content, a variant thereof, or a text stored or generated by the interaction model. These implementations may be used to check alertness, coherence, language proficiency, reliability, and/or the like.

The optional text extraction 222 may be used to convert the interaction input, which may be non-textual to text, for example by voice to text, optical character or gesture recognition, and/or the like.

The content from the interaction input and/or the text extraction may be stored on 124 or on other devices such as 130.

The optional text pre-processing module 230 may be used to adapt the text to work around weaknesses of the large language models, relace known problem words, or translate a text from a first language to a second language, for example, those used on languages other than English, which have lesser representation in available training data. The first language be a language of a small country, a minority language, a jargon, or he like, which may be characterized by lesser presence in the training data of the conversational language model, therefore the language model may perform better on the second language. The second level may be English, however some implementations may use another second language such as Spanish, German, Mandarin Chinese, as well as non-natural languages.

Some implementations may further comprise a domain specific adaptation module, for replacing at least one subsequence of text with a corresponding subsequence of text.

Other examples may relate to frequently used acronyms, abbreviations, jargon, local slang, deliberate typos used to avoid text filters and/or the like. Some implementation may also apply adaptations on incomplete sentences, though in some examples the conversational language model may be robust thereto.

The inspection model 240 may be used to form queries for the conversational language model 242 when a new interaction input arrives, periodically during interaction, following some of the prompts which may be generated by the prompt generator 260 and/or the like. The inspection model may combine one or more inspection questions from 220 with text received from the interaction input, accumulated in storage 124 from the interaction input, and/or the like, to generate one or more queries for the conversational language model.

For example, a portion of the interaction of a user with the interaction model may be:
“Model: Hey, did you see the envelope on the desk? It was here a few minutes ago and now it's gone.
User: No, I didn't see it.
Model: Did you check the drawers?
User: Yes, I checked the top drawer and it's not there, the other drawers are not used for paperwork.
Model: Hmm, that's strange. Maybe someone took it by mistake.
User: I asked around and see if anyone knows about the envelope but no one did”

The inspection model may form queries such as “is the sentence ‘Yes, I checked the top drawer and it's not there, the other drawers are not used for paperwork’ coherent with ‘I asked around and see if anyone knows about the envelope but no one did’?” or “what emotional subtext in No, I didn't see it, Yes, I checked the top drawer and it's not there, the other drawers are not used for paperwork and I asked around and see if anyone knows about the envelope but no one did?”.

The queries may be based on concatenations of inspection questions with parts of the textual content to be presented to the language model, however other methods of forming queries may be used.

Following the interaction model questioning “what would you conclude if some says ‘this sentence is false”’. the inspection module may take a user answer such as “probably trying to confuse”, and form a query such as “when the user answers ‘probably trying to confuse’ to the prompt ‘what would you conclude if some says ‘this sentence is false” indicate the user is confused or tired?”

The conversational language model 242 may be an artificial intelligence module designed to generate text based on a given prompt or input. The model may be an incorporated in house or a third-party machine learning model, which was trained on a large corpus of text and may use deterministic or statistical techniques to generate outputs that are coherent, contextually relevant and semantically meaningful. The language model may be designed to analyze a natural language text and generate responses such as those expected in human conversation. The conversational language may be trained specifically for text classification or inspection, however models trained for variety of applications, such as chat-bots, virtual assistants, private tutor or psychotherapist emulation and customer service systems may also be used.

Conversational and other generative language models may be powered by advanced machine learning techniques, such as neural networks, and may be fine-tuned to perform specific tasks or to generate outputs in specific domains. Conversational language models may comprise components such as generative transformer network, for example for embedding a word placement in a sentence. Some generative language models comprise one or more autoregressive components, however deterministic methods may also be used.

The models may also be integrated into other systems to provide enhanced capabilities, such as improved natural language processing, text generation, and dialogue management. Followingly, the inferences from the language model may be acquired to form a structure to feed into a decision model to acquire a classification of the textual content.

The interaction model 244 may be based on service bots, powered by computerized agents, also used for virtual assistants. The interaction model may function as a chatbot for the purpose of examination, inspection, identity verification, service, sales and or the like. The interaction model can use a variety of methods to ask questions, including knowledge representation, pre-made scripts, or artificial intelligence-based agents. Knowledge representation may be used to store and represent information in a structured way, allowing the chatbot to ask questions based on the user's responses. Pre-made scripts may be used to provide a set of predetermined questions and responses, allowing the chatbot to quickly and accurately respond to the user. Artificial intelligence may be used to allow the chatbot to conduct more complex interaction, learn from the user's responses and adapt its questions and responses accordingly, and/or the like. The interaction model may also be used to provide personalized recommendations and advice to the user.

In some implementation the interaction model may be interconnected with the inspection model and adapt to indications based on evaluation made by the inspection model 240. In such example, as well as in shorter interaction, the interaction model may prompt a user, directly or indirectly, about one or more items. For example, an item such as a peach may be prompted directly by “do you like the taste of peaches”, or indirectly by “name some edible fruits of deciduous trees which may be pink, orange or green”. In examples followed these prompts, the evaluation may comprise evaluating presence of items from the at least one prompt in the textual content, for example, to check the user indeed answers the questions”. The evaluation may be made based on close ended questions, such as ratings or binary, yes or no, questions, however some implementations may relate to open ended questions.

The decision model 250 by receive a plurality of inference values, each generated by the inspection model using the conversational language model, and process them to infer user condition, trustworthiness, performance level, and/or the like. The evaluation inferred by the decision model may be output as an indication and/or used by the prompt generator for generating at least one prompt, which may be used for querying a user for an additional textual content.

Some evaluations may be binary, for example, alert or tired, honest or likely misleading and/or the like. Other examples may have an evaluation of multiple possible values such as “Excellent”, “Good”, “Marginal”, and “Failed”, or “No pathological findings”, “infectious disease” and “non-infectious condition”.

Some other implementations may comprise a classifying machine learning model, i.e., based on an additional machine learning model trained on labelled examples, and/or using other training methods such as active learning to allow less investment in supervision or clustering.

The prompt generator 260 may generate at least one prompt, which may be used for querying a user for an additional textual content

For example, the chatbot conducted by the interaction model may prompt the user with additional questions, recommendations, and/or the like, adapted to the user according to the evaluation made by the decision model 250, in order to gather information, provide a response, recommend a product or service, and/or the like.

Referring now to FIG. 3, which is a flowchart of an exemplary process for dialog inspection, according to some embodiments of the present disclosure. The processing circuitry 120 may execute the exemplary process 300 for a variety of purposes such as examination, investigation, tutoring, customer service, sales, market research, and/or the like. Alternatively, the process 300 or parts thereof may be executing using a remote server or system such as 104, an auxiliary system, and/or the like.

The exemplary process 300 starts, as shown in 302, with accessing a storage to obtain a plurality of inspection questions. The plurality of inspection questions, for example 220, may be obtained from on volatile memory 112, peripheral storage 124, remotely on a private cloud 106, on non-volatile memory and/or the like. inspection question may be open ended, be binary (Yes/No) or multiple choice, and may form a checklist or be related in any arbitrary manner, or apparent lack of relations.

Examples to such questions comprise “What are the potential implications of consuming penicillin V”, “Is there an allergy risk in consuming penicillin V”, “Did you notice anything unusual on your way from the parking lot to the vending machine?” or “Which methods of planting an orange tree on a rocky terrain are preferred”.

The exemplary process 300 continues, as shown in 304, with acquiring a textual content, using a virtual human interaction agent.

The virtual human interaction agent may be based on knowledge representation, machine learning, or hybrid methods, and execute a chatbot for interaction with a user wherein the interaction agent present question along the interaction. The virtual human interaction agent may be a part of the interaction model 244 or comprise an interaction model. The virtual agent may present prompts, textual, vocal, visual, and/or the like to ask the user for a textual content, by typing, speaking, sign language, and/or the like.

Following the user speaking or typing, the textual content, for example 210 may be received by the system through a user interface of the UI device set 126, network module 118, or other data input mechanism. The received text may be stored in volatile memory 112, cache, 122 peripheral storage 124, or the like, to be processed by the system for various applications, such as natural language processing-based text classification. Some implementation may process the textual content in real time, while other may review an interaction after the conversation is finished.

Some implantations may comprise a comprising language adaptation and may translate the textual content or adapt it in other manners. It should also be noted that many natural language processing based translation methods, also referred to as Neural Machine Translation (NMT) such as Bidirectional Encoder Representations from Transformers (BERT) require less training data to achieve adequate reliability such as 90%, 95% or 99% than conversational models require, and are thus accessible for less ubiquitous languages.

The exemplary process 300 continues, as shown in 306, with generating a plurality of queries each from a combination of at least one part of the textual content and one of the plurality of inspection questions. The queries may be generated by the inspection model such as 240, and may combine some or all of the questions from the plurality of questions such as 220 with parts or all of the textual content such as 210. The plurality of queries may be represented in comma separated value files, a list or array of strings, and/or the like, and each query may be in ASCII format, however Unicode, embedding, and other representations may be used.

For example, some implementation may wrap the three last sentences received as textual content from the user with “Does the text . . . mention fatigue?” or add as a prefix to five sentences chosen from the conversation “Is there an internal contradiction in:”.

The exemplary process 300 continues, as shown in 308, with generating a plurality of inference values, each by feeding one of the plurality of queries to at least one conversational language model.

The conversational language model may be executed by the processor set 110, or remotely on the private cloud 106, or the public cloud 150, and/or the like.

The conversational language model such as 250 may be models such as or based on Generative Pretrained Transformer (GPT), Conditional Transformer Language Model (CTRL), Text-to-Text Transfer Transformer (T5), Recurrent neural networks (RNN), Generative Adversarial Networks (GANs), variational autoencoders, and/or the like, as well as models that are expected to be developed. Some implementations may also comprise a knowledge-representation based module, which may be deterministic or stochastic. The conversational language model may generate answers which comprise one of a plurality of answers such as “Yes” and “No”, a number in a range, and/or the like, and these inferences may be fed directly or filtered to a decision model.

The exemplary process 300 continues, as shown in 310, generating at least one evaluation of the textual content by processing the plurality of inference.

The output of the conversational language model may require processing, before being used for determining an additional prompt, an action, and/or the like.

Some inferences may be binary, for example, “Qualified” or “Not qualified”; “Positive” or “Negative” or “lingual correct” or “includes typos”. Other examples may have an inference of multiple possible values such as “Coherent”, “Normal”, “Confused”, and “Severely incoherent” for example for screening, or “Tired”, “Dehydrated”, “Hungry” and “Bored” for a drink vending machine.

The decision may be based on comparing one or more counters to associated thresholds, a decision tree, a machine learning model such as a random forest, a support vector machine, a neural network, and/or the like.

And subsequently, as shown in 312, the process 300 may continue by using the at least one evaluation to generate at least one prompt, and using the at least one prompt for querying a user for an additional textual content.

Some implementations may process the textual content by the inspection model in real time, and use it to adapt or configure the interaction model according to the inspection results. For example, some implementations may generate one or more prompts comprising a suggestion derived from the at least one evaluation.

For example, in a vending machine implementation, an indication of “Tired” may be followed by a prompt, presenting choices of caffeinated drinks such as espresso, cappuccino, green tea, and/or the like. In a context of an online examination, the difficulty level of question may be adapted by the correctness of previous answers.

Some implementation may be used to check student alertness, sincerity, creativity, and or the like, by prompting a deliberately erroneous suggestion, a suggestion comprising an unsolvable puzzle question, and/or the like.

Some implementations may conduct an iterative interaction where evaluations made by the conversational language model are used for developing a conversation, and leading it to discuss certain aspects. For example, the interaction model may query about local news or events, and discuss a road accident which the user might have witnessed. These may be an example where some evaluations may comprise evaluating presence of items from the at least one prompt in the textual content.

Some implementation may repeat a question, or trigger emotional response, to enable evaluation, inferring a mental state induced by a first or consecutive, second or later, prompt. These may be used to detect anger, boredom, depression, elation, or alertness.

Some implementations, real time or following completing the conversation, may be used inferring an emotional state of a user interacting with the virtual human interaction agent.

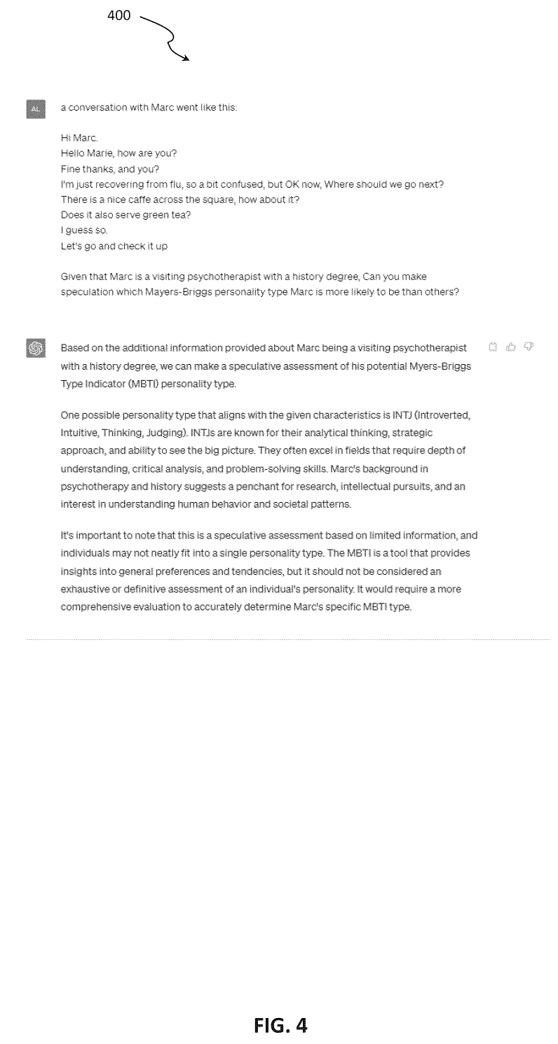

Referring now to FIG. 4, which is an exemplary query to a large language mode and a corresponding inference, according to some embodiments of the present disclosure.

In this example a short conversation, together with some prior knowledge and a question which may be considered close ended as there are 16 Mayer-Briggs personality types, is presented to the ChatGPT conversational language model, and an answer suggesting a personality type which may be more likely than the others.

Some other embodiments may be used to check when a user is concerned, about their weight. A user may conduct a conversation with an assistant executed by the interaction model such as the following:
USER
Hi how are you doing?
ASSISTANT
Hello! I'm doing well, thank you. How can I assist you today?
USER
I don't know, I heard you are a diet consultant
ASSISTANT
Yes, that's correct! I'm here to help with any questions or concerns you may have related to diet and nutrition. Are you interested in learning more about healthy eating habits or do you have a particular question in mind?
USER
I think I gained weight recently, I want to get back in shape and look hot.
ASSISTANT
I understand. May I ask, do you have a specific goal in mind for your weight loss, such as a target weight or dress size? And, have you spoken with a healthcare professional about your weight and how it may be affecting your health?

Similar conversations may be used for inferring other mental condition of a user interacting with the virtual human interaction agent. Followingly, the inspection model may apply the following query on this conversation log:
Query: in the text [THE PREVIOUS CONVERSATION], is the user expressing a desire to lose weight “I used to be a size 10, US system. I am now a size 12 and I hate it, I want to get back to my old clothes”?
Computer: Yes, the user is expressing a desire to lose weight.

Additionally, or alternatively, this query may be made:
Query: in the text delimited by double quotation marks (THE PREVIOUS CONVERSATION), is the user expressing sadness, negativity or anger towards her body weight: “I used to be a size 10, US system. I am now a size 12 and I hate it, I want to get back to my old clothes”?
Computer: Yes, the user is expressing sadness, negativity, and anger towards her body weight.

In another example the assistant ran by the interaction model may function as a story teller, and offer to tell the user a story of a wicked queen who was envious of her pretty daughter. Followingly the queen paid a witch to visit her daughter and offer her a green poisoned apple. The princess ate it and died immediately. Followingly, the interaction model may ask a question about the story. In this example the interaction model may also make queries to the conversational language model. The conversation with the interaction model or assistant may be:
USER
Hi how are you doing?
ASSISTANT
I'm doing fine. Do you want me to tell you a story?
USER
Yes, sure please tell it.
ASSISTANT
Once upon a time, there was a wicked queen who was envious of her pretty daughter. The queen was jealous of her daughter's beauty and wanted to be the fairest of them all. So, she paid a witch to visit her daughter and offer her a green poisoned apple. The princess, who was innocent and unsuspecting, ate the apple and died immediately. The queen was devastated by her daughter's death, but she did not show any remorse. Instead, she pretended to be heartbroken and ordered a grand funeral for her daughter. However, the people in the kingdom knew the truth and were outraged by the queen's actions.
As time passed, the queen's guilt and shame grew stronger. She could not bear the weight of her conscience and eventually confessed to her crime. The people of the kingdom were shocked and angry, and they demanded justice for the princess.
The queen was put on trial and found guilty of murder. She was sentenced to life imprisonment in a dark and lonely dungeon. There, she spent the rest of her days in solitude, haunted by the memory of her daughter and the terrible deed she had committed.
The people of the kingdom mourned the loss of their beloved princess.
ASSISTANT
Can you tell me some things in the story which are UNLIKE the original Snow-White Story?
USER
Well, in the original Snow-White story the princess does not die, she only goes into a comma. Also, in the original story she is first banished to the forest and lives with the famous seven dwarves. Also, in the original story it is not clear what happens to the evil queen as the prince who saves snow white takes her to his kingdom. I also noted in the story you told me; the fruit given to the princess was not red like in the original Snow-White story.

Followingly, the inspection model may use the conversational language model to answer this query:
Query: in the text delimited by double quotation marks, is the user referring to the color of the apple given to the princess as different from the one in the original snow-white story: “Well, in the original Snow-White story the princess does not die, she only goes into a comma. Also, in the original story she is first banished to the forest and lives with the famous seven dwarves. Also, in the original story it is not clear what happens to the evil queen as the prince who saves snow white takes her to his kingdom. I also noted in the story you told me, the fruit given to the princess was not red like in the original Snow-White story.
Computer: Yes, the user is referring to the color of the apple being different from the one in the original Snow-White story.

It should be noted that the above examples are specific, and based on the ChatGPT model, however other queries and models are known to the person skilled in the art and will be developed in the future and are withing the scope of the claims.

It is expected that during the life of a patent maturing from this application many relevant conversational language models, text media, and representation methods will be developed and the scope of the terms conversational language models machine learning model, text, and embedding are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for evaluating understanding in a textual content, comprising:
accessing a storage to obtain a plurality of inspection questions;
acquiring a textual content, using a virtual human interaction agent;
using at least one processing circuitry for generating:
a plurality of queries each from a combination of at least one part of the textual content and one of the plurality of inspection questions;
a plurality of inference values, each by feeding one of the plurality of queries to at least one conversational language model; and
at least one evaluation of the textual content by processing the plurality of inference.

2. The method of claim 1, further comprising using the at least one evaluation to generate at least one prompt, and using the at least one prompt for querying a user for an additional textual content.

3. The method of claim 2, wherein the at least one prompt comprising a suggestion derived from the at least one evaluation.

4. The method of claim 3, wherein the suggestion is deliberately erroneous.

5. The method of claim 4, wherein the suggestion comprising an unsolvable puzzle question.

6. The method of claim 3, wherein the suggestion is a request to rephrase a part of the textual content.

7. The method of claim 2, wherein the at least one evaluation comprising evaluating presence of items from the at least one prompt in the textual content.

8. The method of claim 2, wherein the at least one evaluation is inferring a mental state induced by the least one second prompt.

9. The method of claim 1, wherein the at least one evaluation pertains to consistency of reactions to a plurality of prompts virtual human interaction agent, wherein the plurality of prompts are characterized by equivalence.

10. The method of claim 1, wherein the at least one evaluation is inferring a mental condition of a user interacting with the virtual human interaction agent.

11. The method of claim 1, wherein the at least one evaluation is inferring an emotional state of a user interacting with the virtual human interaction agent.

12. The method of claim 1, wherein the evaluation comprising using the at least one conversational language model to check correctness and completeness of the textual content.

13. A system comprising a storage and at least one processing circuitry configured to:
access the storage to obtain a plurality of inspection questions;
acquire a textual content, using a virtual human interaction agent;
use the at least one processing circuitry for generating:
a plurality of queries each from a combination of at least one part of the textual content and one of the a plurality of inspection questions;
a plurality of inference values, each by feeding one of the plurality of queries to at least one conversational language model; and
at least one evaluation of the textual content by processing the plurality of inference.

14. The system of claim 13, further comprising using the at least one evaluation to generate at least one prompt, and using the at least one prompt for querying the group of users for an additional textual content.

15. The system of claim 14, wherein the at least one prompt comprising a suggestion derived from the at least one evaluation.

16. The system of claim 15, wherein the suggestion is deliberately erroneous.

17. The system of claim 16, wherein the suggestion comprising an unsolvable puzzle question.

18. The system of claim 15, wherein the suggestion is a request to rephrase a part of the textual content.

19. The system of claim 14, wherein the at least one evaluation comprising evaluating presence of items from the at least one prompt in the textual content.

20. The system of claim 14, wherein the at least one evaluation is inferring a mental state induced by the least one second prompt.

21. The system of claim 13, wherein the at least one evaluation pertains to consistency of reactions to a plurality of prompts virtual human interaction agent, wherein the plurality of prompts are characterized by equivalence.

22. The system of claim 13, wherein the at least one evaluation is inferring a mental condition of a user interacting with the virtual human interaction agent.

23. The system of claim 13, wherein the at least one evaluation is inferring an emotional state of a user interacting with the virtual human interaction agent.

24. The system of claim 13, wherein the evaluation comprising using the at least one conversational language model to check correctness and completeness of the textual content.

25. One or more computer program products comprising instructions for evaluating understanding in a textual content, wherein execution of the instructions by one or more processors of a computing system is to cause a computing system to:
access a storage to obtain a plurality of inspection questions;
acquire a textual content, using a virtual human interaction agent;
use at least one processing circuitry for generating:
a plurality of queries each from a combination of at least one part of the textual content and one of the plurality of inspection questions;
a plurality of inference values, each by feeding one of the plurality of queries to at least one conversational language model; and
at least one evaluation of the textual content by processing the plurality of inference.
